(19) United States
(12) Patent Application Publication
(10) Pub. No.: US 2017/0244084 A1
(43) Pub. Date: Aug. 24, 2017

(54) EXPANDER DEVICE, POROUS FILM PRODUCTION APPARATUS, AND POROUS FILM PRODUCING METHOD

(71) Applicant: Sumitomo Chemical Company, Limited, Tokyo (JP)

(72) Inventors: Koichiro WATANABE, Niihama-shi (JP); Daizaburo YASHIKI, Niihama-shi (JP)

(21) Appl. No.: 15/434,243

(22) Filed: Feb. 16, 2017

(30) Foreign Application Priority Data
Feb. 19, 2016 (JP) 2016-030298

(51) Int. Cl. H01M 2/14; B29C 55/02; H01M 10/0525

(52) U.S. Cl. CPC H01M 2/145; H01M 10/0525; B29C 55/023; B29K 2023/06; B29K 2023/12

(57) ABSTRACT

To prevent adherence of foreign matter such as wear powder to a film, an expander device (21) includes: an expander roller (22) configured to apply a tension to a film (F) in the width direction of the film (F); and a sucking section (26) configured to suck foreign matter into the expander roller (22) through a sucking port provided at an outer peripheral surface of the expander roller (22).

### CROSS-REFERENCE TO RELATED APPLICATIONS

This Nonprovisional application claims priority under 35 U.S.C. §119 on Patent Application No. 2016-030298 filed in Japan on Feb. 19, 2016, the entire contents of which are hereby incorporated by reference.

### TECHNICAL FIELD

The present invention relates to an expander device, a porous film production apparatus, and a porous film producing method.

### BACKGROUND ART

A heat-resistant separator (porous film) for a lithium-ion secondary battery is produced as follows: While a porous film as a base material is being transferred with use of a transfer system including a transfer roller, the porous film undergoes steps such as (i) a coating step of coating a surface of the porous film with a coating material to be used as a heat-resistant layer and (ii) a drying step of drying the coating material.

The transfer system includes (i) a driving roller configured to apply a transfer tension to a porous film, (ii) a guide roller configured to adjust the transfer direction, and (iii) an expander roller configured to prevent wrinkles in a porous film being transferred.

The use of an expander roller, however, involves friction between the expander roller and the porous film. This friction wears out the porous film, leaving wear powder. Such wear powder adhering to the porous film may hinder a later step.

Patent Literature 1 discloses a device for smoothing wrinkles in a web, the device including (i) a plurality of rolls arranged in a direction so inclined at an angle that the plurality of rolls open in the transfer direction of the web, (ii) a sucking port surrounding each roll, and (iii) a sucking means for sucking air through the sucking port.

The wrinkle smoothing device disclosed in Patent Literature 1 sucks air through the sucking port to adsorb a web onto the roll and thus imparts a widening force to the web being transferred. This makes it possible to smooth wrinkles in a web. Further, even in a case where frictional contact between a web and a roll causes wear powder to be generated, the wrinkle smoothing device can suck such wear powder through the sucking port for removal.

### CITATION LIST

### Patent Literature

[Patent Literature 1] Japanese Patent Application Publication, Tokukaihei, No. 4-223135 (Publication Date: Aug. 13, 1992)

### SUMMARY OF INVENTION

### Technical Problem

The wrinkle smoothing device disclosed in Patent Literature 1 is designed to suck air through the sucking port surrounding each roll and thereby adsorb a web onto each roll. The sucking port is, however, excessively large for a sucking port to suck wear powder. The wrinkle smoothing device thus has a low efficiency of sucking wear powder.

The present invention has been accomplished in view of the above issue. It is an object of the present invention to provide an expander device, a porous film production apparatus, and a porous film producing method, each of which can efficiently suck wear powder generated from a film.

### Solution to Problem

In order to attain the above object, an expander device of an embodiment of the present invention includes: an expander roller configured to apply a tension to a film in a width direction of the film; and a sucking section configured to suck foreign matter into the expander roller through a sucking port provided at an outer peripheral surface of the expander roller.

In order to attain the above object, a porous film production apparatus of an embodiment of the present invention includes: a transfer system including the expander device; and a processing section configured to process the film, which is being transferred, into a porous film.

In order to attain the above object, a porous film producing method of an embodiment of the present invention includes the step of: producing a porous film with use of the porous film production apparatus.

### Advantageous Effects of Invention

An embodiment of the present invention makes it possible to provide an expander device, a porous film production apparatus, and a porous film producing method, with each of which wear powder will not adhere to a film.

### BRIEF DESCRIPTION OF DRAWINGS

FIG. 1 is a diagram schematically illustrating a cross sectional configuration of a lithium-ion secondary battery.

FIG. 2 shows diagrams each schematically illustrating a state of the lithium-ion secondary battery illustrated in FIG. 1.

FIG. 3 shows diagrams each schematically illustrating a state of a lithium-ion secondary battery having another configuration.

FIG. 4 is a flow diagram schematically illustrating a process of producing a heat-resistant separator.

FIG. 5 is a diagram schematically illustrating how a porous film is transferred with use of a conventional expander roller.

FIG. 6 shows diagrams each schematically illustrating an example shape of an expander roller of an embodiment of the present invention.

FIG. 7 shows diagrams each schematically illustrating an expander device of Embodiment 1.

FIG. 8 shows diagrams each schematically illustrating a state in which a porous film is transferred with use of an expander device of Embodiment 1.

FIG. 9 shows diagrams each schematically illustrating an expander device in accordance with a variation of Embodiment 1.

FIG. 10 shows diagrams each schematically illustrating a state in which a porous film is transferred with use of an expander device in accordance with a variation of Embodiment 1.

FIG. 11 is a diagram schematically illustrating an expander device in accordance with another variation of Embodiment 1.

FIG. 12 shows diagrams each schematically illustrating a state in which a porous film is transferred with use of an expander device in accordance with another variation of Embodiment 1.

FIG. 13 shows diagrams each schematically illustrating an expander device of Embodiment 2.

FIG. 14 shows diagrams each schematically illustrating a state in which a porous film is transferred with use of an expander device of Embodiment 2.

FIG. 15 shows diagrams each schematically illustrating an expander device in accordance with a variation of Embodiment 2.

FIG. 16 shows diagrams each schematically illustrating a state in which a porous film is transferred with use of an expander device in accordance with a variation of Embodiment 2.

### DESCRIPTION OF EMBODIMENTS

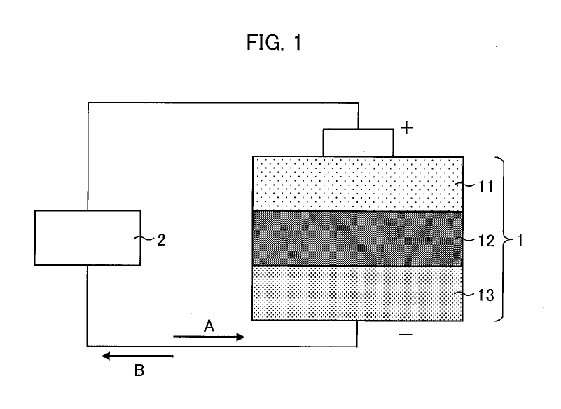

The following description will discuss embodiments of the present invention in detail with reference to FIGS. 1 to 10. The description below deals with a heat-resistant separator for a battery such as a lithium-ion secondary battery as an example film (porous film) in accordance with an embodiment of the present invention.

### Embodiment 1

<Configuration of Lithium-Ion Secondary Battery>

A nonaqueous electrolyte secondary battery, typically a lithium-ion secondary battery, has a high energy density, and is therefore currently widely used not only as batteries for use in devices such as personal computers, mobile phones, and mobile information terminals, and for use in moving bodies such as automobiles and airplanes, but also as stationary batteries contributing to stable power supply.

FIG. 1 is a diagram schematically illustrating a cross-sectional configuration of a lithium-ion secondary battery 1.

As illustrated in FIG. 1, the lithium-ion secondary battery 1 includes a cathode 11, a separator 12, and an anode 13. Between the cathode 11 and the anode 13, an external device 2 is connected outside the lithium-ion secondary battery 1. While the lithium-ion secondary battery is being charged, electrons move in a direction A. Meanwhile, while the lithium-ion secondary battery 1 is being discharged, electrons move in a direction B.

<Separator>

The separator 12 is provided so as to be sandwiched between the cathode 11 (as a positive electrode) and the anode 13 (as a negative electrode) of the lithium-ion secondary battery 1. While separating the cathode 11 and the anode 13, the separator 12 allows lithium ions to move between the cathode 11 and the anode 13. The separator 12 contains, for example, a polyolefin (for example, polyethylene or polypropylene) as a material thereof.

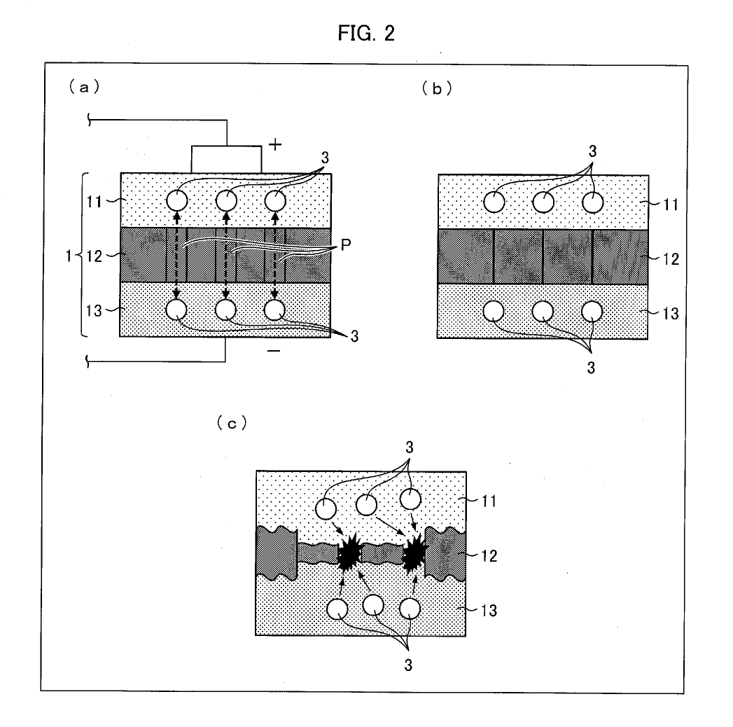

FIG. 2 shows diagrams each schematically illustrating a state of the lithium-ion secondary battery 1 illustrated in FIG. 1. (a) of FIG. 2 illustrates a normal state. (b) of FIG. 2 illustrates a state in which the temperature of the lithium-ion secondary battery 1 has risen. (c) of FIG. 2 illustrates a state in which the temperature of the lithium-ion secondary battery 1 has sharply risen.

As illustrated in (a) of FIG. 2, the separator 12 is provided with many pores P. Normally, lithium ions 3 in the lithium-ion secondary battery 1 can move back and forth through the pores P.

Note here that there may be, for example, a case where the lithium-ion secondary battery 1 increases in temperature due to, for example, (i) overcharge of the lithium-ion secondary battery 1 or (ii) a large current caused by a short circuit having occurred in an external device. In such cases, the separator 12 melts or softens, and the pores P are blocked as illustrated in (b) of FIG. 2. As a result, the separator 12 shrinks. This stops the movement of the lithium ions 3, and consequently stops the increase in temperature (described earlier).

Note, however, that the separator 12 suddenly shrinks in a case where the lithium-ion secondary battery 1 sharply increases in temperature. In this case, as illustrated in (c) of FIG. 2, the separator 12 may be broken. Then, the lithium ions 3 leak out from the separator 12 which has been broken, so that the lithium ions 3 do not stop moving back and forth. Thus, the increase in temperature continues.

<Heat-Resistant Separator>

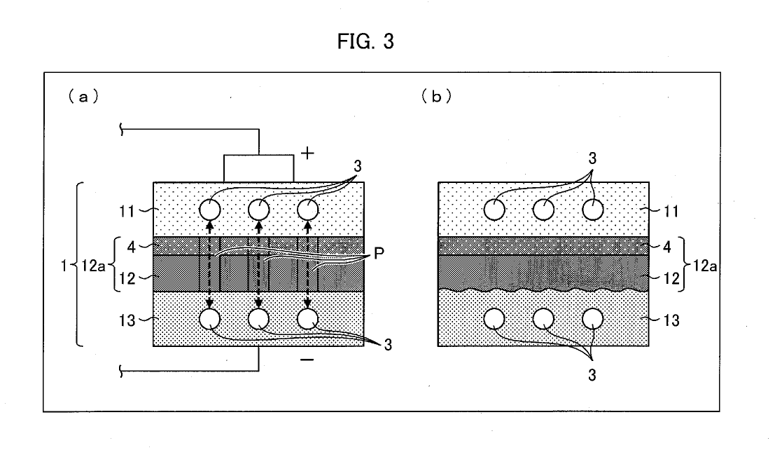

FIG. 3 shows diagrams each schematically illustrating a state of a lithium-ion secondary battery 1 having another configuration. (a) of FIG. 3 illustrates a normal state. (b) of FIG. 3 illustrates a state in which the temperature of the lithium-ion secondary battery 1 has sharply risen.

As illustrated in (a) of FIG. 3, the lithium-ion secondary battery 1 can further include a heat-resistant layer 4. The heat-resistant layer 4 can be provided on the separator 12. (a) of FIG. 3 illustrates a configuration in which a heat-resistant layer 4 as a functional layer is provided on the separator 12. The description below uses the term “heat-resistant separator 12a” to refer to a film that combines the separator 12 and the heat-resistant layer 4 provided thereon.

The configuration illustrated in (a) of FIG. 3 includes a heat-resistant layer 4 laminated on one surface of the separator 12 which surface is on the cathode 11 side. The heat-resistant layer 4 may alternatively be laminated on (i) a surface of the separator 12 which surface is on the anode 13 side or on (ii) both surfaces of the separator 12. Further, the heat-resistant layer 4 is provided with pores that are similar to the pores P. Normally, lithium ions 3 move back and forth through the pores P and the pores of the heat-resistant layer 4. The heat-resistant layer 4 contains, for example, wholly aromatic polyamide (aramid resin) as a material thereof.

As illustrated in (b) of FIG. 3, even in a case where the temperature of the lithium-ion secondary battery 1 has sharply risen and accordingly the separator 12 has melted or softened, the shape of the separator 12 is maintained because the heat-resistant layer 4 supports the separator 12. Thus, such a sharp increase in temperature merely results in melting or softening of the separator 12 and consequent blocking of the pores P. This stops the movement of the lithium ions 3, and consequently stops overdischarge and overcharge (described earlier). The separator 12 is thus prevented from being broken.

<Method for Producing Heat-Resistant Separator (Method for Producing Porous Film>

The following description will discuss how a heat-resistant separator is produced with use of a porous film production apparatus of Embodiment 1.

The heat-resistant separator 12a includes (i) a porous film serving as the separator 12 and (ii) a heat-resistant layer laminated thereon. The porous film contains, for example, a polyolefin. The heat-resistant layer may be replaced with a functional layer such as an adhesive layer. A heat-resistant layer is laminated on the porous film by (i) coating a surface of the porous film with, for example, a coating material for the heat-resistant layer and (ii) drying the coating material.

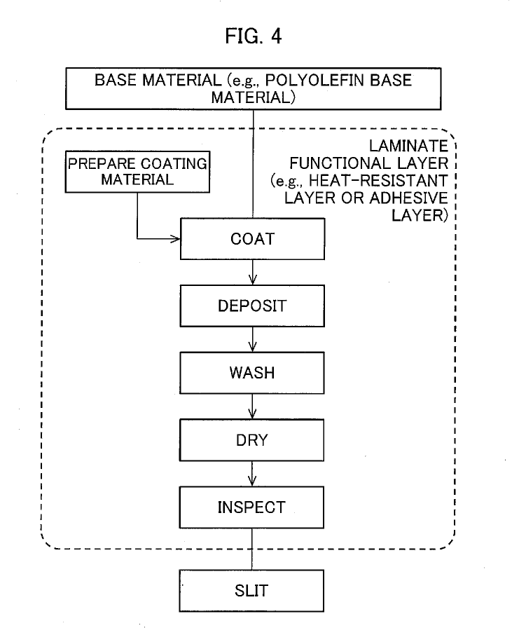

FIG. 4 is a flow diagram schematically illustrating a process of producing a heat-resistant separator.

According to the flow illustrated in FIG. 4, the heat-resistant layer contains wholly aromatic polyamide (aramid resin) as a material, and is laminated on a polyolefin base material.

The process of producing a heat-resistant separator including a heat-resistant layer made of aramid resin includes in sequence (a) a step of unwinding and inspecting a porous film, (b) a step of coating the porous film with a coating material (functional material), (c) a step of depositing the coating material by, for example, humidification, (d) a washing step, (e) a drying step, (f) a coated article inspecting step, and (g) a winding step.

The process of producing a heat-resistant separator including a heat-resistant layer containing an inorganic filler as a main component includes in sequence (a) a step of unwinding and inspecting a porous film, (b) a step of coating the porous film with a coating material (functional material), (e) a drying step, (f) a coated article inspecting step, and (g) a winding step.

Further, the process of producing a heat-resistant separator may include, in addition to the above steps (a) through (g), a base material producing (film forming) step carried out before the unwinding and inspecting step (a) and/or a slitting step carried out after the winding step (g).

The following description will discuss the steps (a) to (g) in sequence.

(a) Unwinding Step and Inspecting Step

The unwinding step is a step of unwinding, from a roller, a porous film as a base material for a heat-resistant separator. The inspecting step is a step of inspecting the unwound porous film before coating it in the next step.

(b) Coating Step

The coating step is a step of coating the porous film unwound in the step (a) with a coating material as a functional material. The description below deals with how a heat-resistant layer is laminated on a porous film. Specifically, the porous film is coated with an N-methyl-pyrrolidone (NMP) solution of aramid, which solution serves as a coating material for the heat-resistant layer. Note that the heat-resistant layer is not limited to the above aramid heat-resistant layer. For example, the porous film can be coated with, for example, a suspension containing an inorganic filler (for example, a suspension containing alumina, carboxymethylcellulose, and water), which suspension serves as a coating material for the heat-resistant layer. The method for coating the porous film with a coating material is not particularly limited provided that uniform wet coating can be carried out by the method. The method can be exemplified by various methods such as a capillary coating method, a slit die coating method, a spray coating method, a dip coating method, a roller coating method, a screen printing method, a flexo printing method, a gravure coater method, a bar coater method, and a die coater method. The heat-resistant layer 4 has a thickness which can be controlled by (i) adjusting the thickness of the coating material with which the porous film is coated or (ii) adjusting the solid-content concentration of the coating material.

(c) Depositing Step

The depositing step is a step of solidifying the coating material with which the porous film has been coated in the step (b). In a case where the coating material is an NMP solution of aramid, the aramid is solidified by, for example, providing vapor to a coating surface and thereby causing humid deposition.

(d) Washing Step

The washing step is a step of removing the solvent by washing the coating material deposited in the step (c). As a result of removal of the solvent, an aramid heat-resistant layer is formed on the base substrate. In a case where the heat-resistant layer is an aramid heat-resistant layer, water, an aqueous solution, or an alcoholic solution, for example, is suitably used as a washing liquid.

(e) Drying Step

The drying step is a step of drying the heat-resistant separator which has been washed in the step (d). The method for drying the heat-resistant separator is not particularly limited but can be any of various methods such as (i) a method of bringing the heat-resistant separator into contact with a heated roller and (ii) a method of blowing hot air on the heat-resistant separator. In a case where a heat-resistant layer is to be formed that contains an inorganic filler as a main component, the porous film is coated with a suspension (coating material) containing an inorganic filler and is subsequently dried, and then the solvent is removed for formation of a heat-resistant layer on the porous film.

(e) Inspecting Step

The inspecting step is a step of inspecting the heat-resistant separator which has been dried. During the inspection, a defective part may be marked as appropriate so that the defective part can be easily removed.

(f) Winding Step

The winding step is a step of winding the heat-resistant separator which has been inspected. The winding can be carried out by appropriately using, for example, a cylindrical core. The wound heat-resistant separator can be, for example, directly shipped in the form of a wide original sheet. Alternatively, if necessary, the wound heat-resistant separator can be formed into a slit separator by being slit so as to have a narrow width such as a product width.

<Production Device>

As described above, the process of producing a heat-resistant separator includes steps such as a coating step, a depositing step, a washing step, a drying step, an inspecting step, and a slitting step. The operation during each step is carried out while the porous film is being subjected to a tension in the longitudinal direction of the porous film for transfer. This allows a heat-resistant separator to be produced.

A porous film production apparatus includes, for example, (i) devices configured to carry out the above steps such as a coating device (processing section), a depositing device, a washing device, a drying device, an inspecting device, and a slitting device, and (ii) a transfer system configured to transfer a porous film to the individual devices.

The transfer system includes (i) a plurality of transfer rollers configured to transfer a porous film and (ii) an expander device including an expander roller configured to apply a tension to the porous film in the width direction of the porous film F to prevent wrinkles in the porous film.

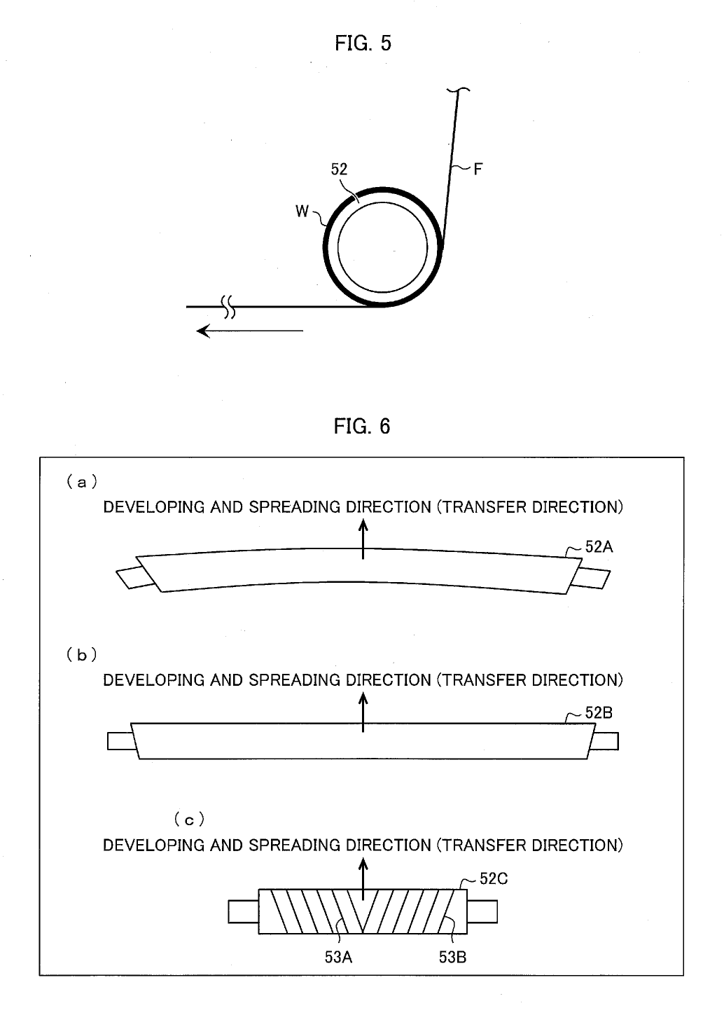

FIG. 5 is a diagram schematically illustrating how a porous film is transferred with use of a conventional expander roller. FIG. 5 shows an arrow to indicate the direction in which a porous film F is transferred. The use of an expander roller 52 in a transfer system as illustrated in FIG. 5 involves friction between the expander roller 52 and the porous film F. This friction wears out the porous film F, leaving wear powder W. Such wear powder W adhering to the porous film F may hinder a later step.

A porous film production apparatus of Embodiment 1 can, in contrast, prevent wear powder W from adhering to a porous film F as described below.

FIG. 6 shows diagrams each schematically illustrating an example shape of an expander roller included in an expander device of an embodiment of the present invention.

The expander roller of an embodiment of the present invention can be any of various conventionally publicly known rollers. FIG. 6 shows examples of the expander roller.

Examples of the expander roller include (i) a curved roller 52A (banana roller) having a curved axis as illustrated in (a) of FIG. 6, (ii) a cylindrical roller 52B having a non-curved axis as illustrated in (b) of FIG. 6, and (iii) a roller 52C having grooves 53A and 53B each in the shape of a spiral that curves away from the center toward one of both ends as illustrated in (c) of FIG. 6.

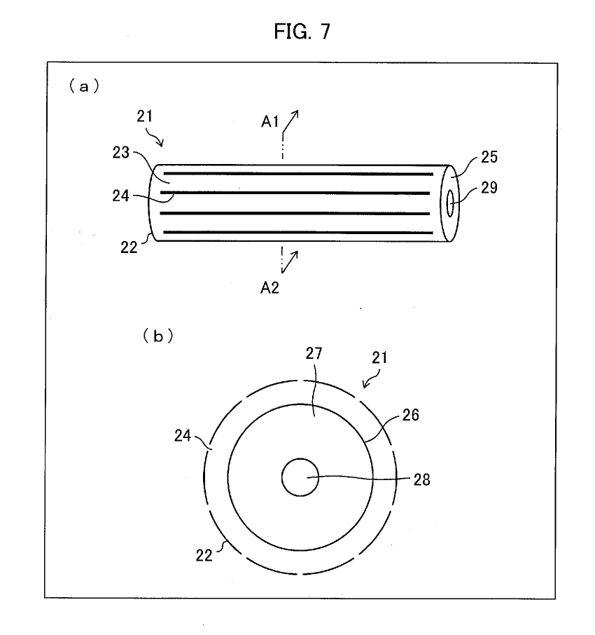

FIG. 7 shows diagrams each schematically illustrating an expander device of Embodiment 1. (a) of FIG. 7 is a diagram schematically illustrating how the expander device appears. (b) of FIG. 7 is a diagram illustrating a cross section of the expander device, taken along line A1-A2 in (a) of FIG. 7.

As illustrated in (a) of FIG. 7, the expander device 21 of Embodiment 1 includes an expander roller 22. The expander roller 22 is a substantially cylindrical roller, and includes belt-shaped bands 23 on an outer peripheral surface thereof. The expander roller 22 has openings 24 between the bands 23, the openings 24 connecting the inside of the expander device 22 to the outside thereof. The openings 24, which are provided on the outer peripheral surface of the expander roller 22, each function as a sucking port for sucking air.

The expander roller 22 has opposite side surfaces that are closed with respective ends 25. The ends 25 each have an air outlet 29 for connecting to the inside of the expander roller 22.

The bands 23 each extend in a direction substantially parallel to the longitudinal direction of the expander roller 22, and are arranged at fixed intervals to form a substantial circle in cross section. The bands 23 thus form the outer peripheral surface of the expander roller 22. The bands 23 are separated from one another by a distance, which defines the width of each opening 24. The openings 24 are closed at the opposite ends of the bands 23. The bands 23 are thus integrated with one another.

As illustrated in (b) of FIG. 7, the expander roller 22 contains a sucking section 26. The sucking section 26 includes a sucking device 27 and a dirt container 28. The sucking section 26 is fixed to the ends 25, so that rotating the expander roller 22 also rotates the sucking section 26 similarly.

The sucking device 27 sucks outside air through the openings 24 of the expander roller 22 in all directions. The sucking device 27 can use any of various conventionally publicly known sucking systems. The sucking device 27 may, for example, use a built-in fan to suck foreign matter together with outside air. The sucking device 27 sucks foreign matter such as wear powder W, which is then conveyed to the dirt container 28.

The dirt container 28 temporarily stores foreign matter sucked by the sucking device 27. Air sucked together with foreign matter is conveyed through the dirt container 28 to be discharged from the air outlets 29.

The air outlets 29 are each provided with a filter (not shown). The filter is used to discharge only sucked air and keep foreign matter in the dirt container 28. The filter can be any of various publicly known filters as long as the filter is structured to allow passage of any object that is smaller than the assumed foreign matter.

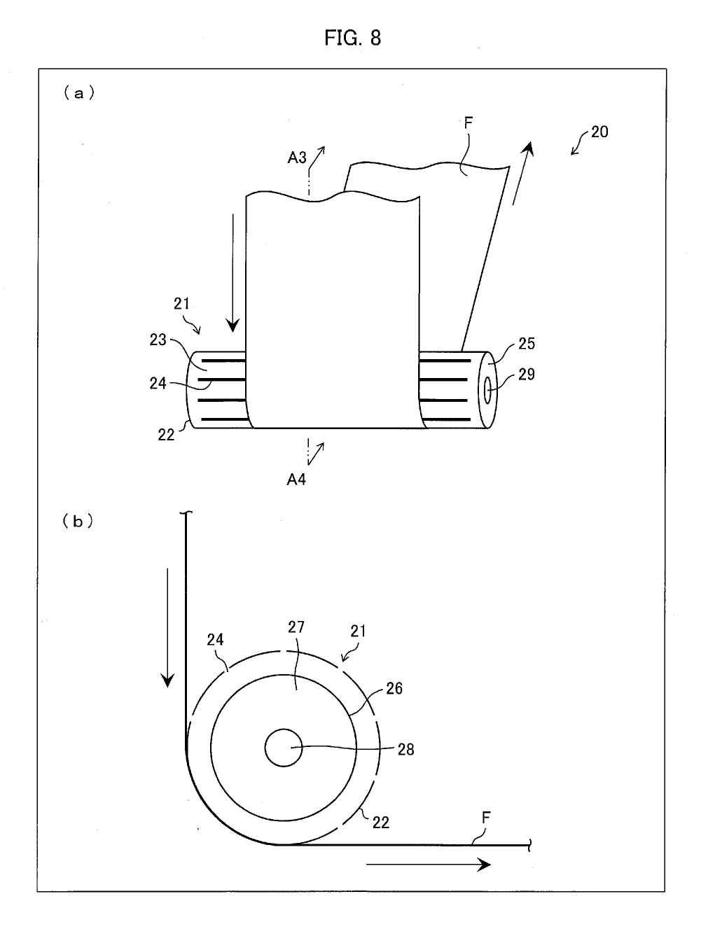

FIG. 8 shows diagrams each schematically illustrating a state in which a porous film F is transferred with use of an expander device of the porous film production apparatus of Embodiment 1. (a) of FIG. 8 is a diagram schematically illustrating how the porous film production apparatus appears. (b) of FIG. 8 is a diagram illustrating a cross section of the porous film production apparatus, taken along line A3-A4 in (a) of FIG. 8. FIG. 8 shows arrows to indicate the direction in which a porous film F is transferred.

As illustrated in (a) of FIG. 8, a porous film production apparatus 20 of Embodiment 1 includes an expander device 21. The expander device 21 is set so that the expander roller 22 extends in the width direction of a porous film F. The expander roller 22 extending in the width direction of the porous film F means that the expander roller 22 is so oriented to have a longitudinal direction substantially parallel to the width direction of the porous film F.

The expander roller 22 is in contact with the porous film F in the longitudinal direction of the expander roller 22. The expander roller 22 applies a tension to the porous film F in the width direction of the porous film F at a portion at which the expander roller 22 is in contact with the porous film F.

The expander roller 22 may be a driving roller or a driven roller.

Operating the sucking section 26 in the above state causes the sucking device 27 to suck (i) gas inside the expander roller 22 and (ii) outside gas through the openings 24 between the bands 23.

As illustrated in (b) of FIG. 8, while a film F is being transferred, the film F comes into contact with a portion of the outer peripheral surface of the expander roller 22. The sucking device 27 performs the sucking operation through the openings 24. Since the inside of the expander roller 22 is closed at any portion other than the openings 24, the sucking device 27 can perform the sucking operation in all directions, that is, through all the openings 24.

At a portion of the outer peripheral surface of the expander roller 22 at which portion the expander roller 22 is in contact with the porous film F, the sucking device 27 can suck, through the corresponding opening(s) 24, foreign matter such as wear powder W adhering to or generated from the porous film F.

At a portion of the outer peripheral surface of the expander roller 22 at which portion the expander roller 22 is in no contact with the porous film F, the sucking device 27 can suck, through the corresponding opening(s) 24, foreign matter such as wear powder W adhering to a portion of the outer peripheral surface which portion is near the openings 24.

The above configuration makes it possible to suck wear powder W generated from a porous film F and thus prevent wear powder W from adhering to a porous film F.

The outer peripheral surface of the expander roller 22 is separated from a porous film F by a small distance. The expander roller 22 thus sucks a porous film F. This makes it possible to suck foreign matter with use of only a low sucking capability.

The expander device 21 may alternatively be arranged as follows: Foreign matter sucked by the sucking device 27 is put into the dirt container 28, and is stored in the dirt container 28 temporarily. When the operation of the porous film production apparatus 20 is stopped, for example, when (i) the lot is replaced or (ii) the film has been broken, the foreign matter is collected for disposal.

Outside air sucked is filtered through the filters, and is then discharged from the air outlets 29.

The sucking section 26 of Embodiment 1 is built in the expander roller 22. This makes it possible to save space. The present invention can be implemented even in a case where there is no space enough for a sucking section around the expander roller 22.

Embodiment 1 is an example in which the expander roller 22 is in the shape of a substantial cylinder and has a non-curved axis. The present invention is, however, not limited to such a configuration. Embodiment 1 is applicable similarly to, for example, an expander roller having a shape similar to that of the curved roller 52A, which has a curved axis, as illustrated (a) of FIG. 6.

The bands 23 of the expander roller 22 each preferably have a smooth curved surface. This configuration allows a porous film F to be in tight contact with the outer peripheral surface of the expander roller 22, thereby increasing the force of holding a porous film F and facilitating sucking wear powder. The present invention is, however, not limited to such a configuration. Embodiment 1 is also applicable to, for example, an expander roller having a shape similar to that of the roller 52C, which has grooves, as illustrated in (c) of FIG. 6.

<Variation 1>

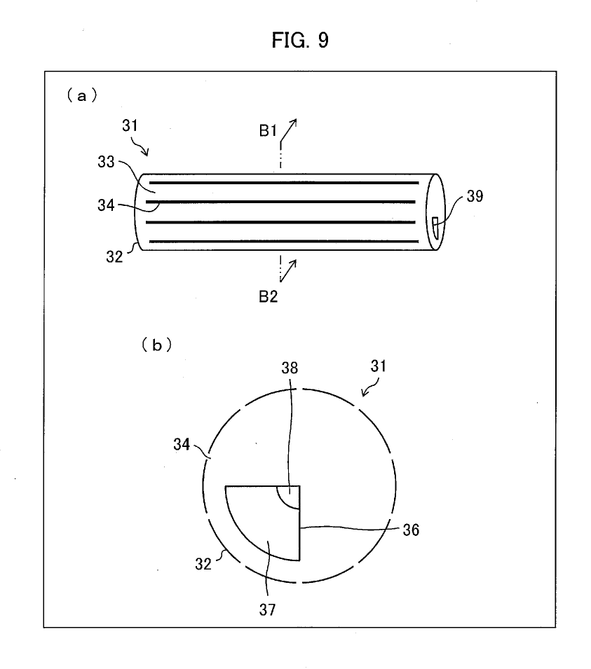

FIG. 9 shows diagrams each schematically illustrating an expander device in accordance with a variation of Embodiment 1. (a) of FIG. 9 is a diagram schematically illustrating how the expander device appears. (b) of FIG. 9 is a diagram illustrating a cross section of the expander device, taken along line B1-B2 in (a) of FIG. 9.

As illustrated in (a) of FIG. 9, an expander device 31 of Variation 1 includes an expander roller 32. The expander roller 32 is a substantially cylindrical roller, and includes bands 33 on an outer peripheral surface thereof. The expander roller 32 has openings 34 between the bands 33, the openings 34 connecting the inside of the expander device 32 to the outside thereof. The openings 34 each function as a sucking port for sucking air.

As illustrated in (b) of FIG. 9, the expander roller 32 contains a sucking section 36. The sucking section 36 includes a sucking device 37 and a dirt container 38. The sucking section 36 is fixed independently of the rotation axis of the expander roller 32, so that rotating the expander roller 32 does not rotate the sucking section 36, leaving the sucking section 36 unmoved and remaining at the position illustrated in FIG. 9.

The sucking device 37 sucks outside air through the openings 34 of the expander roller 32 only in a direction in which the sucking section 36 faces. The sucking device 37 sucks foreign matter such as wear powder W, which is then conveyed to the dirt container 38.

The dirt container 38 temporarily stores foreign matter sucked by the sucking device 37. Air sucked together with foreign matter is conveyed through the dirt container 38 to be discharged from air outlets 39.

The air outlets 39 are each provided with a filter (not shown). The filter is used to discharge only sucked air and keep foreign matter in the dirt container 38.

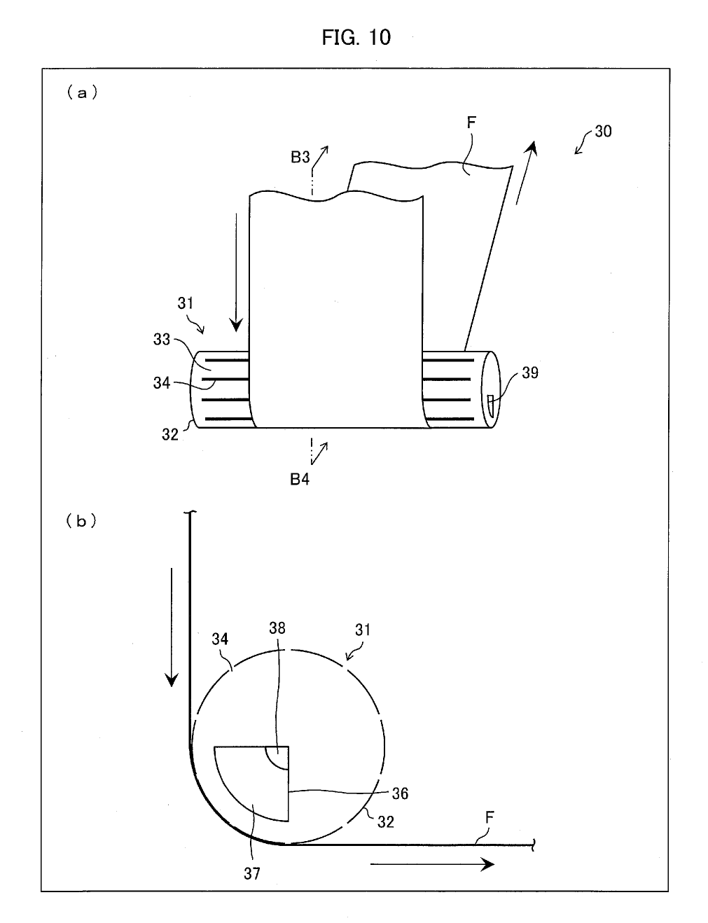

FIG. 10 shows diagrams each schematically illustrating a state in which a porous film F is transferred with use of an expander device of the porous film production apparatus of Variation 1. (a) of FIG. 10 is a diagram schematically illustrating how the porous film production apparatus appears. (b) of FIG. 10 is a diagram illustrating a cross section of the porous film production apparatus, taken along line B3-B4 in (a) of FIG. 10. FIG. 10 shows arrows to indicate the direction in which a porous film F is transferred.

As illustrated in (a) of FIG. 10, a porous film production apparatus 30 of Variation 1 includes an expander device 31. The expander device 31 is set so that the expander roller 32 extends in the width direction of a porous film F.

The expander roller 32 is in contact with the porous film F in the longitudinal direction of the expander roller 32. The expander roller 32 applies a tension to the porous film F in the width direction of the porous film F at a portion at which the expander roller 32 is in contact with the porous film F.

The expander roller 32 may be a driving roller or a driven roller.

Operating the sucking section 36 in the above state causes the sucking device 37 to suck (i) gas inside the expander roller 32 and (ii) outside gas through the openings 34 between the bands 33.

As illustrated in (b) of FIG. 10, the sucking section 36 is provided to face the portion of contact between the expander roller 32 and a film F. The sucking device 37 performs the sucking operation through the corresponding opening(s) 34 in the direction in which the sucking section 36 faces, that is, the direction in which the contact portion lies as viewed from the center of the expander roller 32. FIG. 10 illustrates an example in which the expander roller 32 is in contact with a porous film F only at a fourth of the outer peripheral surface of the expander roller 32.

At a portion of the outer peripheral surface of the expander roller 32 at which portion the expander roller 32 is in contact with the porous film F, the sucking device 37 can suck, through the corresponding opening(s) 34, foreign matter such as wear powder W adhering to or generated from the porous film F.

The above configuration makes it possible to suck wear powder W generated from a porous film F and thus prevent wear powder W from adhering to a porous film F.

The expander device 31 may be arranged as follows: Foreign matter sucked by the sucking device 37 is put into the dirt container 38, and is stored in the dirt container 38 temporarily. When the operation of the porous film production apparatus 30 is stopped, for example, when (i) the lot is replaced or (ii) the film has been broken, the foreign matter is collected for disposal.

Outside air sucked is filtered through the filters, and is then discharged from the air outlets 39.

The porous film production apparatus 30 of Variation 1 is configured to perform the sucking operation only in a direction in which the portion at which the expander roller 32 is in contact with the film lies as viewed from the center of the expander roller 32. This configuration makes it possible to suck wear powder W efficiently.

<Variation 2>

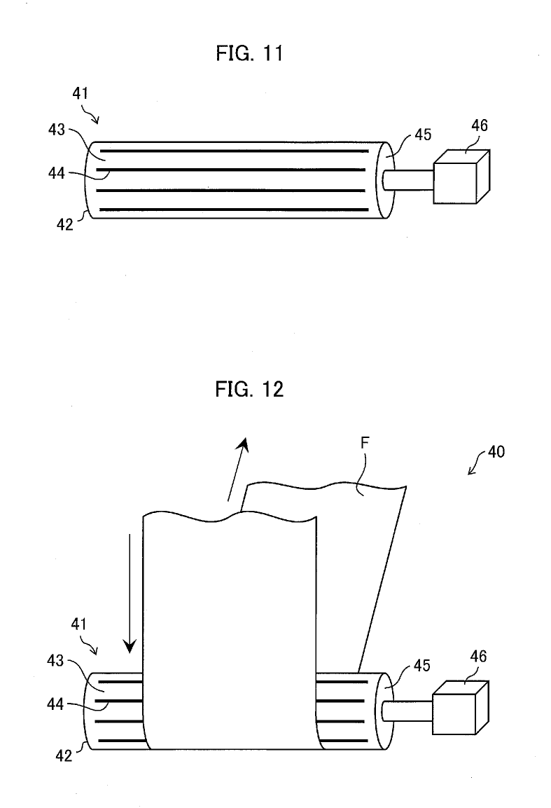

FIG. 11 is a diagram schematically illustrating an expander device in accordance with another variation of Embodiment 1.

As illustrated in FIG. 11, an expander device 41 of Variation 2 includes an expander roller 42 and a sucking section 46. The expander roller 42 is a substantially cylindrical roller, and includes bands 43 on an outer peripheral surface thereof. The expander roller 42 has openings 44 between the bands 43, the openings 44 connecting the inside of the expander device 42 to the outside thereof.

The expander roller 42 has opposite side surfaces that are closed with respective ends 45.

Variation 2 is compared with Embodiment 1 above such that the sucking section 46 is provided outside the expander roller 42 and connected to the inside of the expander roller 42 through an end 45. The sucking section 46 includes a sucking device, a dirt container, and air outlets (not shown) as with the sucking sections described above.

FIG. 12 is a diagram schematically illustrating a state in which a porous film F is transferred with use of an expander device of a porous film production apparatus in accordance with another variation of Embodiment 1.

As illustrated in FIG. 12, a porous film production apparatus 40 of Variation 2 includes an expander device 41. The expander device 41 is set so that the expander roller 42 extends in the width direction of a porous film F. FIG. 12 shows an arrow to indicate the direction in which a porous film F is transferred.

Operating the sucking section 46 in the above state causes the sucking device to suck (i) gas inside the expander roller 42 and (ii) outside gas through the openings 44 between the bands 43.

At a portion of the outer peripheral surface of the expander roller 42 at which portion the expander roller 42 is in contact with the porous film F, the sucking device can suck, through the corresponding opening(s) 44, foreign matter such as wear powder W adhering to or generated from the porous film F.

At a portion of the outer peripheral surface of the expander roller 42 at which portion the expander roller 42 is in no contact with the porous film F, the sucking device can suck, through the corresponding opening(s) 44, foreign matter such as wear powder W adhering to a portion of the outer peripheral surface which portion is near the openings 44.

Foreign matter is first sucked by the sucking device of the sucking section 46 (which is provided outside the expander roller 42), put into the expander roller 42, and then put into the dirt container of the sucking section 46. Outside air sucked is discharged from the air outlets.

The above configuration makes it possible to suck wear powder W generated from a porous film F and thus prevent wear powder W from adhering to a porous film F.

The sucking section 46 of Variation 2, which is provided outside the expander roller 42, eliminates the need for a complicated structure inside the expander roller 42. Further, the sucking section 46 can suck not only wear powder W of a porous film F, but also foreign matter inside the expander roller 42. This can reduce the need to regularly remove foreign matter such as wear powder W accumulating inside the expander roller 42.

Variation 2 is an example in which a single sucking section 46 is connected to a single expander roller 42 for the sucking operation. The present invention is, however, not limited to such a configuration. As an alternative example, a single sucking section 46 may be connected to two or more expander rollers 42 for the sucking operation.

Variation 2 is an example in which the sucking device performs the sucking operation through the openings 44 of the expander roller 42 in all directions. The present invention is, however, not limited to such a configuration. The present invention may alternatively be configured, for example, such that (i) the sucking section 36 of the expander roller 32 illustrated in FIGS. 9 and 10 is replaced with a cavity in which foreign matter is put temporarily and that (ii) a side surface for the cavity communicates to an outside sucking section. This allows an outside sucking section to suck foreign matter only through the corresponding opening(s) 44 in a portion of the outer peripheral surface at which portion the expander roller 42 is in contact with a film.

### Embodiment 2

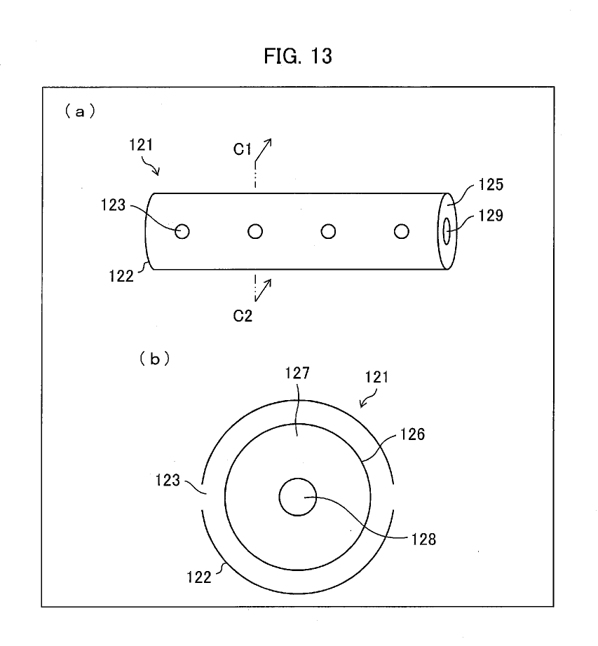

The following description will discuss another embodiment of the present invention with reference to FIGS. 13 to 16. Note that, for convenience of explanation, identical reference numerals are given to members which have respective functions identical with those described in Embodiment 1, and descriptions of the respective members are omitted.

FIG. 13 shows diagrams each schematically illustrating an expander device of Embodiment 2. (a) of FIG. 13 is a diagram schematically illustrating how the expander device appears. (b) of FIG. 13 is a diagram illustrating a cross section of the expander device, taken along line C1-C2 in (a) of FIG. 13.

As illustrated in (a) of FIG. 13, an expander device 121 in accordance with Embodiment 2 includes an expander roller 122. The expander roller 122 is a substantially cylindrical roller, and includes at least one hole 123 in an outer peripheral surface thereof, the holes 123 connecting the inside of the expander device 122 to the outside thereof. The holes 123 are, for example, formed in the outer peripheral surface in two columns that are symmetric with respect to the center of the expander roller 122. The holes 123 each function as a sucking port for sucking air.

The expander roller 122 has opposite side surfaces that are closed with respective ends 125. The ends 125 each have an air outlet 129 for connecting to the inside of the expander roller 122.

As illustrated in (b) of FIG. 13, the expander roller 122 contains a sucking section 126. The sucking section 126 includes a sucking device 127 and a dirt container 128. The sucking section 126 is fixed to the ends 125, so that rotating the expander roller 122 also rotates the sucking section 126 similarly.

The sucking device 127 performs the sucking operation through all the holes 123 in the expander roller 122. The sucking device 127 sucks foreign matter such as wear powder W, which is then conveyed to the dirt container 128.

The dirt container 128 temporarily stores foreign matter sucked by the sucking device 127. Air sucked together with foreign matter is conveyed through the dirt container 128 to be discharged from the air outlets 129.

The air outlets 129 are each provided with a filter (not shown). The filter is used to discharge only sucked air and keep foreign matter in the dirt container 128.

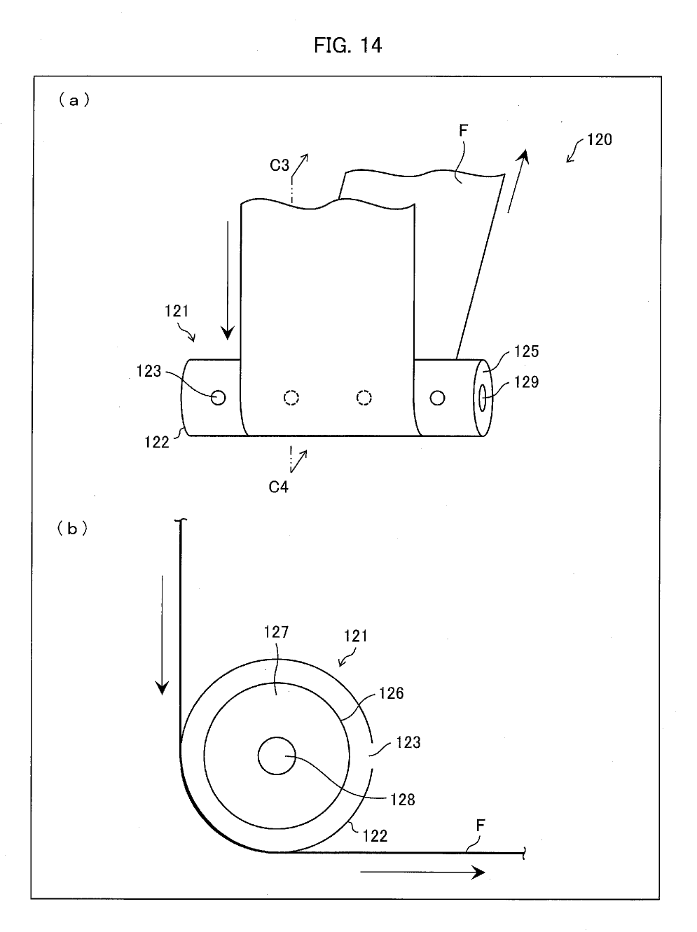

FIG. 14 shows diagrams each schematically illustrating a state in which a porous film F is transferred with use of an expander device of a porous film production apparatus of Embodiment 2. (a) of FIG. 14 is a diagram schematically illustrating how the porous film production apparatus appears. (b) of FIG. 14 is a diagram illustrating a cross section of the porous film production apparatus, taken along line C3-C4 in (a) of FIG. 14. FIG. 14 shows arrows to indicate the direction in which a porous film F is transferred.

As illustrated in (a) of FIG. 14, a porous film production apparatus 120 of Embodiment 2 includes an expander device 121. The expander device 121 is set so that the expander roller 122 extends in the width direction of a porous film F.

The expander roller 122 is in contact with the porous film F in the longitudinal direction of the expander roller 122. The expander roller 122 applies a tension to the porous film F in the width direction of the porous film F at a portion at which the expander roller 122 is in contact with the porous film F.

Operating the sucking section 126 in the above state causes the sucking device 127 to suck (i) gas inside the expander roller 122 and (ii) outside gas through the holes 123.

As illustrated in (b) of FIG. 14, the holes 123, which are formed in the outer peripheral surface of the expander roller 122, connect the inside of the expander roller 122 to the outside thereof. The sucking device 127 performs the sucking operation through the holes 123. Since the inside of the expander roller 122 is closed at any portion other than the holes 123, the sucking device 127 can perform the sucking operation in all directions, that is, through all the holes 123.

At a portion of the outer peripheral surface of the expander roller 122 at which portion the expander roller 122 is in contact with the porous film F, the sucking device 127 can suck, through the corresponding hole(s) 123, foreign matter such as wear powder W adhering to or generated from the porous film F.

At a portion of the outer peripheral surface of the expander roller 122 at which portion the expander roller 122 is in no contact with the porous film F, the sucking device 127 can suck, through the corresponding hole(s) 123, foreign matter such as wear powder W adhering to a portion of the outer peripheral surface which portion is near the holes 123.

The above configuration makes it possible to suck wear powder W generated from a porous film F and thus prevent wear powder W from adhering to a porous film F.

The expander device 121 may alternatively be arranged as follows: Foreign matter sucked by the sucking device 127 is put into the dirt container 128, and is stored in the dirt container 128 temporarily. When the operation of the porous film production apparatus 120 is stopped, for example, when (i) the lot is replaced or (ii) the film has been broken, the foreign matter is collected for disposal.

Outside air sucked is filtered through the filters, and is then discharged from the air outlets 129.

Embodiment 2 is an example in which the holes 123 are each in a circular shape. The present invention is, however, not limited to such a configuration. The holes 123 may alternatively be in any of various shapes such as a rectangular shape. Further, the arrangement and number of holes 123 may be changed variously.

Embodiment 2 is arranged such that the shape, arrangement, and/or number of holes 123 may be changed as appropriate in correspondence with the state and/or properties of the porous film F. This arrangement can reduce damage caused by a sucking operation on the porous film F. In a case where, for example, a porous film F is transferred that is thin and low in strength, reducing the size and number of holes 123 can reduce force applied to the film, thereby preventing, for example, breakage caused by a sucking operation.

<Variations>

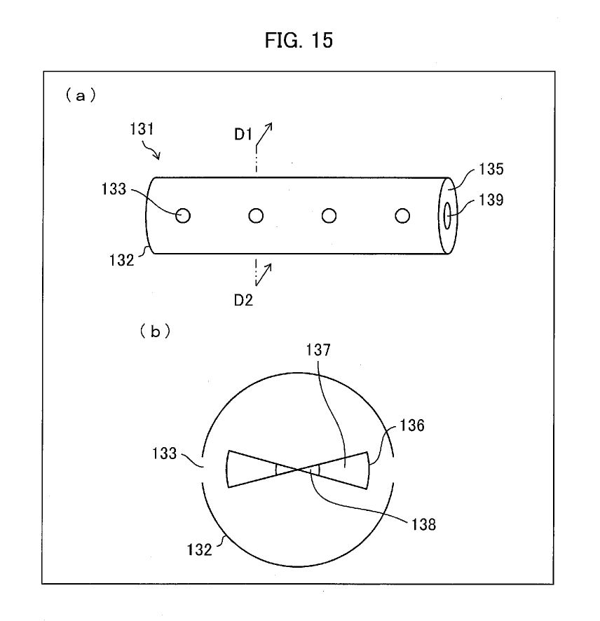

FIG. 15 shows diagrams each schematically illustrating an expander device in accordance with a variation of Embodiment 2. (a) of FIG. 15 is a diagram schematically illustrating how the expander device appears. (b) of FIG. 15 is a diagram illustrating a cross section of the expander device, taken along line D1-D2 in (a) of FIG. 15.

As illustrated in (a) of FIG. 15, an expander device 131 in accordance with the variation of Embodiment 2 includes an expander roller 132. The expander roller 132 is a substantially cylindrical roller, and includes at least one hole 133 in an outer peripheral surface thereof, the holes 133 connecting the inside of the expander device 132 to the outside thereof. The holes 133 are, for example, formed in the outer peripheral surface in two columns that are symmetric with respect to the center of the expander roller 132. The holes 133 each function as a sucking port for sucking air.

The expander roller 132 has opposite side surfaces that are closed with respective ends 135. The ends 135 each have an air outlet 139 for connecting to the inside of the expander roller 132.

As illustrated in (b) of FIG. 15, the expander roller 132 contains a sucking section 136. The sucking section 136 includes a sucking device 137 and a dirt container 138. The sucking section 136 is fixed to the ends 135, so that rotating the expander roller 132 also rotates the sucking section 136 similarly.

The sucking device 137 is provided to face the holes 133 in the expander roller 132. The sucking device 137 thus sucks outside air in the direction in which the holes 133 are located as viewed from the sucking device 137. The sucking device 137 sucks foreign matter such as wear powder W, which is then conveyed to the dirt container 138.

The dirt container 138 temporarily stores foreign matter sucked by the sucking device 137. Air sucked together with foreign matter is conveyed through the dirt container 138 to be discharged from the air outlets 139.

The air outlets 139 are each provided with a filter (not shown). The filter is used to discharge only sucked air and keep foreign matter in the dirt container 138.

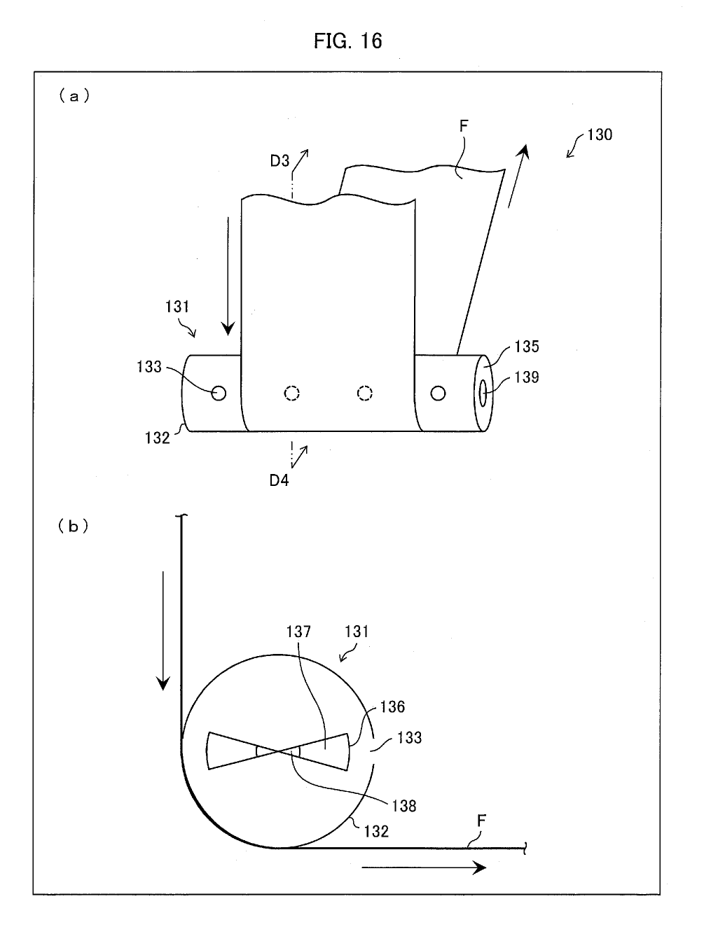

FIG. 16 shows diagrams each schematically illustrating a state in which a porous film F is transferred with use of an expander device of a porous film production apparatus in accordance with a variation of Embodiment 2. (a) of FIG. 16 is a diagram schematically illustrating how the porous film production apparatus appears. (b) of FIG. 16 is a diagram illustrating a cross section of the porous film production apparatus, taken along line D3-D4 in (a) of FIG. 16. FIG. 16 shows arrows to indicate the direction in which a porous film F is transferred.

As illustrated in (a) of FIG. 16, a porous film production apparatus 130 of the variation of Embodiment 2 includes an expander device 131. The expander device 131 is set so that the expander roller 132 extends in the width direction of a porous film F.

The expander roller 132 is in contact with the porous film F in the longitudinal direction of the expander roller 132. The expander roller 132 applies a tension to the porous film F in the width direction of the porous film F at a portion at which the expander roller 132 is in contact with the porous film F.

Operating the sucking section 136 in the above state causes the sucking device 137 to suck (i) gas inside the expander roller 132 and (ii) outside gas through the holes 133.

As illustrated in (b) of FIG. 16, the sucking device 137 is provided to face the holes 133 in the outer peripheral surface of the expander roller 132. The sucking device 137 performs the sucking operation through a hole(s) 133 that the sucking device 137 is provided to face.

At a portion of the outer peripheral surface of the expander roller 132 at which portion the expander roller 132 is in contact with the porous film F, the sucking device 137 can suck, through the corresponding hole(s) 133, foreign matter such as wear powder W adhering to or generated from the porous film F.

At a portion of the outer peripheral surface of the expander roller 132 at which portion the expander roller 132 is in no contact with the porous film F, the sucking device 137 can suck, through the corresponding hole(s) 133, foreign matter such as wear powder W adhering to a portion of the outer peripheral surface which portion is near the holes 133.

The above configuration makes it possible to suck wear powder W generated from a porous film F and thus prevent wear powder W from adhering to a porous film F.

The expander device 131 may alternatively be arranged as follows: Foreign matter sucked by the sucking device 137 is put into the dirt container 138, and is stored in the dirt container 138 temporarily. When the operation of the porous film production apparatus 130 is stopped, for example, when (i) the lot is replaced or (ii) the film has been broken, the foreign matter is collected for disposal.

Outside air sucked is filtered through the filters, and is then discharged from the air outlets 139.

The sucking section 136 of the present variation can only be provided to face the holes 133. This makes it possible to suck foreign matter such as wear powder W with a lower sucking capability.

The present variation is an example in which the holes 133 are formed in the outer peripheral surface of the expander roller 132 in two columns. The present invention is, however, not limited to such a configuration. The sucking section 136 may be designed to have any of various shapes in correspondence with the shape, arrangement, and/or number of holes 133. This makes it possible to design holes 133 variously.

The present variation is an example in which the sucking section 136 is fixed to the ends 135, so that rotating the expander roller 132 rotates the sucking section 136 as well. The present invention is, however, not limited to such a configuration. The present invention may be configured, for example, such that the sucking section 136 is fixed independently of the rotation axis of the expander roller 132 and that the sucking section 136 performs the sucking operation only when the holes 133 become located in the direction in which the sucking section 136 performs the sucking operation.

In addition to the above configuration, the present invention may be configured such that the sucking section 136 performs the sucking operation only in a direction in which the expander roller 132 is in contact with a film, as with the sucking section 36 illustrated in FIGS. 9 and 10. This configuration allows the sucking section 136 to perform the sucking operation only when the holes 133 become located at a portion at which the expander roller 132 is in contact with a film.

[Recap]

An expander device in accordance with an embodiment of the present invention includes: an expander roller configured to apply a tension to a film in a width direction of the film; and a sucking section configured to suck foreign matter into the expander roller through a sucking port provided at an outer peripheral surface of the expander roller.

The above configuration prevents a gap between the expander roller and the sucking port. This makes it possible to perform a sucking operation without decreasing the force of holding a film through the sucking operation.

The expander device may be configured such that the expander roller extends in the width direction of the film.

The above configuration makes it possible to remove foreign matter from a film all across the film.

The expander device may be configured such that the sucking section is provided inside the expander roller.

The above configuration, which allows the sucking section to be contained in the expander roller, makes it possible to save space.

The expander device may be configured such that the sucking section is provided outside the expander roller and communicates to inside of the expander roller.

The above configuration eliminates the need for a complicated structure inside the expander roller and can reduce the need to regularly remove foreign matter accumulating inside the expander roller.

The expander device may be configured such that the expander roller includes bands constituting the outer peripheral surface; and the sucking section sucks the foreign matter into the expander roller through an opening between the bands.

The above configuration makes it possible to produce an expander roller into which foreign matter is sucked, without specially processing the outer peripheral surface of the expander roller having bands.

The expander device may be configured such that the expander roller has at least one hole in the outer peripheral surface; and the sucking section sucks the foreign matter into the expander roller through the at least one hole.

The above configuration makes it possible to design the position and/or size of holes in the expander roller in correspondence with the properties of a film to be produced.

The expander device may preferably be configured such that the expander roller is a driving roller.

The above configuration makes it possible to apply a transfer force to the film with use of the expander roller.

A porous film producing device in accordance with an embodiment of the present invention includes: a transfer system including the expander device; and a processing section configured to process the film, which is being transferred, into a porous film.

A porous film producing method in accordance with an embodiment of the present invention is producing a porous film with use of the porous film production apparatus.

[Supplemental Notes]

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### REFERENCE SIGNS LIST

12 Separator
12a Heat-resistant separator (porous film)
20, 30, 40, 120, 130 Porous film production apparatus
21, 31, 41, 121, 131 Expander device
22, 32, 42, 122, 132 Expander roller
23, 33, 43 Band
24, 34, 44 Opening
25, 45, 125, 135 End
26, 36, 46, 126, 136 Sucking section
27, 37, 127, 137 Sucking device
28, 38, 128, 138 Dirt container
29, 39, 129, 139 Air outlet
123, 133 Hole
F Porous film (film)
W Wear powder W (foreign matter)

1. An expander device, comprising:
an expander roller configured to apply a tension to a film in a width direction of the film; and
a sucking section configured to suck foreign matter into the expander roller through a sucking port provided at an outer peripheral surface of the expander roller.

2. The expander device according to claim 1, wherein
the expander roller extends in the width direction of the film.

3. The expander device according to claim 1, wherein
the sucking section is provided inside the expander roller.

4. The expander device according to claim 1, wherein
the sucking section is provided outside the expander roller and communicates to inside of the expander roller.

5. The expander device according to claim 1, wherein:
the expander roller includes bands constituting the outer peripheral surface; and
the sucking section sucks the foreign matter into the expander roller through an opening between the bands.

6. The expander device according to claim 1, wherein:
the expander roller has at least one hole in the outer peripheral surface; and
the sucking section sucks the foreign matter into the expander roller through the at least one hole.

7. The expander device according to claim 1, wherein
the expander roller is a driving roller.

8. A porous film production apparatus, comprising:
a transfer system including an expander device according to claim 1; and
a processing section configured to process the film, which is being transferred, into a porous film.

9. A porous film producing method for producing a porous film, the porous film producing method comprising: the step of processing a film while transferring the film,
the transferring involving use of an expander roller,
the expander roller having a sucking port at an outer peripheral surface thereof,
the expander roller being configured to suck foreign matter into the expander roller through the sucking port.
